(19) United States
(12) Patent Application Publication
(10) Pub. No.: US 2011/0157129 A1
(43) Pub. Date: Jun. 30, 2011

(54) SOURCE DRIVER CIRCUIT OF LIQUID CRYSTAL DISPLAY DEVICE

(75) Inventors: Hyun-Min SONG, Cheongju-si (KR); Young-Suk Son, Daejeon-si (KR); Ji-Hum Kim, Daejeon-si (KR); Joon-Ho Na, Daejeon-si (KR)

(73) Assignee: SILICON WORKS CO., LTD, Daejeon-si (KR)

(21) Appl. No.: 12/974,584

(22) Filed: Dec. 21, 2010

(30) Foreign Application Priority Data
Dec. 24, 2009 (KR) 10-2009-0130991

(51) Int. Cl. G09G 3/36; G09G 5/00

(52) U.S. Cl. 345/211; 345/87

(57) ABSTRACT

A source driver circuit of a liquid crystal display device including a gamma buffer. The gamma buffer includes a differential amplification section configured to differentially amplify an input signal; a current mirror section configured to operate as a current mirror; an enable section configured to convert the differential amplification section from a standby mode to an enable mode by a bias voltage; a power drop speed improvement section configured to respectively connect drains of the two PMOS transistors of the current mirror section and drains of the two NMOS transistors of the differential amplification section through two diode coupling type MOS transistors, and shorten a recovery time after a power drop; and an output section configured to be determined in a bias level thereof by the bias voltage and generate an output voltage according to a voltage of a downstream node on one side of the current mirror section.

### BACKGROUND OF THE INVENTION

1. Field of the Invention

The present invention relates to a technology for stably supplying the output voltage of a source driver circuit in a liquid crystal display device, and more particularly, to a source driver circuit of a liquid crystal display device which can shorten the recovery time of the output voltage of a gamma buffer when a power drop occurs in a source driver circuit.

2. Description of the Related Art

FIG. 1 is a block diagram illustrating a driving circuit of a conventional liquid crystal display device. Referring to FIG. 1, the driving circuit of a conventional liquid crystal display device includes a flexible printed circuit (FPC) 120 including a gamma voltage supply unit and disposed on a printed circuit board (PCB) 110, and a source driver integrated device 130 configured to receive gamma voltages from the gamma voltage supply unit of the flexible printed circuit 120 and drive the data lines of a liquid crystal display panel 140. In the liquid crystal display panel 140, the liquid crystals disposed in the type of a matrix are driven by the gradation voltages supplied through the data lines so as to display a picture.

The source driver integrated device 130 includes an upper end gamma voltage buffer unit 131P constituted by a plurality of gamma buffers GMBP1 through GMBPn which receive and output upper end gamma voltages VP1 through VPn, a lower end gamma voltage buffer unit 131N constituted by a plurality of gamma buffers GMBN1 through GMBNn which receive and output lower end gamma voltages VN1 through VNn, a digital-to-analog (D/A) converter 132 configured to convert the digital signals outputted from the upper and lower end gamma voltage buffer units 131P and 131N into analog signals, and a channel buffer unit 133 constituted by channel buffers CHB which buffer the analog voltages of corresponding channels, outputted from the D/A converter 132 and output the buffered analog voltages to the data lines.

The data lines of the liquid crystal display panel 140 are constituted by a plurality of resistor (R) and capacitor (C) loads when viewed in terms of equivalent circuits. In order for the source driver integrated device 130 to drive the liquid crystal display panel 140, the R/C loads should be charged and discharged.

When it is necessary to drive the data lines to levels higher than previous levels, the source driver integrated device 130 receives voltages through a power supply terminal VDD from the gamma voltage supply unit of the flexible printed circuit 120 and charges the R/C loads. When it is necessary to drive the data lines to levels lower than previous levels, the source driver integrated device 130 discharges the voltages charged in the R/C loads. In FIG. 1, the reference symbol CP indicates a charging path, and DCP indicates a discharging path.

Such charging and discharging processes are repeatedly performed, and current is consumed during these processes. According to the amount of consumed current, the magnitudes of resistance of resistors R_VDD on connection lines extending from the flexible printed circuit 120 to the power supply terminal VDD of the source driver integrated device 130, and the magnitudes of resistance of resistors R_GND on connection lines extending from the flexible printed circuit 120 to a ground terminal GND of the source driver integrated device 130, the voltage of the power supply terminal VDD undergoes a drop, and the voltage of the ground terminal GND undergoes a bouncing.

The amount of consumed current is proportional to the capacitance values of the capacitors C of the data lines on the liquid crystal display panel 140 and to the number of channel buffers CHB of the source driver integrated device 130.

In a COG (chip-on-glass) type liquid crystal display device, since all connections between the flexible printed circuit 120 and the source driver integrated device 130 are formed in an LOG (line-on-glass) type, all LOG type connections have resistance values equal to or greater than several ohms.

Due to this fact, the resistors R_VDD and the resistors R_GND are provided. Further, as described above, since current is consumed through the resistors R_VDD when charging the R/C loads, a drop occurs in the voltage of the power supply terminal VDD, and since current is consumed through the resistors R_GND when discharging the R/C loads, a bouncing occurs in the voltage of the ground terminal GND.

Due to such power drop and bouncing phenomena, the gamma buffers GMBP1 through GMBPn and GMBN1 through GMBNn in the source driver integrated device 130 are influenced, and because the output terminals of the gamma buffers GMBP1 through GMBPn and GMBN1 through GMBNn are connected to the input terminals of the channel buffers CHB through the D/A converter 132, the outputs of the channel buffers CHB are influenced as well and are changed.

FIG. 2 is a graph showing changes in the output voltage of an optional gamma buffer GMB in the upper and lower end gamma voltage buffer units 131P and 131N and changes in the output voltages of an optional channel buffer CHB in the channel buffer unit 133, due to the power drop and bouncing phenomena.

Referring to FIG. 2, if the voltage of the power supply terminal VDD drops when charging the R/C loads, the output voltage GMB_OUT of the gamma buffer GMB drops correspondingly. In this regard, when the output voltage GMB_OUT of the gamma buffer GMB is raised to a desired level after the drop occurs, it can be understood that the output voltage GMB_OUT of the gamma buffer GMB is raised not quickly but slowly.

Accordingly, it can be appreciated that the output voltage CHB_OUT of the channel buffer CHB is raised in a slow pattern like the output voltage GMB_OUT of the gamma buffer GMB.

Also, if the voltage of the ground terminal GND bounces when discharging the R/C loads, the output voltage GMB_OUT of the gamma buffer GMB bounces correspondingly. In this regard, when the output voltage GMB_OUT of the gamma buffer GMB is lowered to an original level after the bouncing occurs, it can be understood that the output voltage GMB_OUT of the gamma buffer GMB is lowered not quickly but relatively slowly. Accordingly, it can be appreciated that the output voltage CHB_OUT of the channel buffer CHB is lowered in a slow pattern like the output voltage GMB_OUT of the gamma buffer GMB.

As a consequence, in the source driver integrated device of the conventional liquid crystal display device, the output voltage of the gamma buffer is recovered to the original level not quickly but slowly when charging and discharging the R/C loads. Thus, the output voltage of the channel buffer is lowered in a slow pattern like the output voltage of the gamma buffer.

### SUMMARY OF THE INVENTION

Accordingly, the present invention has been made in an effort to solve the problems occurring in the related art, and an object of the present invention is to provide a source driver circuit of a liquid crystal display device which is designed in such a way as to be capable of shortening the recovery time of the output voltage of a gamma buffer in a source driver integrated device when a drop of the voltage of a power supply terminal and a bouncing of the voltage of a ground terminal occur in a source driver circuit.

In order to achieve the above object, according to one aspect of the present invention, there is provided a source driver circuit of a liquid crystal display device including a gamma buffer, the gamma buffer comprising a differential amplification section having two NMOS transistors and configured to differentially amplify an input signal; a current mirror section having two PMOS transistors and configured to operate as a current mirror; an enable section having one NMOS transistor and configured to convert the differential amplification section from a standby mode to an enable mode by a bias voltage; a power drop speed improvement section configured to respectively connect drains of the two PMOS transistors of the current mirror section and drains of the two NMOS transistors of the differential amplification section through two diode coupling type MOS transistors, and shorten a recovery time after a power drop; and an output section having a PMOS transistor and an NMOS transistor and configured to be determined in a bias level thereof by the bias voltage and generate an output voltage according to a voltage of a downstream node on one side of the current mirror section.

In order to achieve the above object, according to one aspect of the present invention, there is provided a source driver circuit of a liquid crystal display device including a gamma buffer, the gamma buffer comprising a differential amplification section having two PMOS transistors and configured to differentially amplify an input signal; a current mirror section having two NMOS transistors and configured to operate as a current mirror; an enable section having one PMOS transistor and configured to convert the differential amplification section from a standby mode to an enable mode by a bias voltage; a power drop speed improvement section configured to respectively connect drains of the two PMOS transistors of the differential amplification section and drains of the two NMOS transistors of the current mirror section through two diode coupling type MOS transistors, and shorten a recovery time after a bouncing in a voltage of a ground terminal; and an output section having an NMOS transistor and a PMOS transistor and configured to be determined in a bias level thereof by the bias voltage and generate an output voltage according to a voltage of an upstream node on one side of the current mirror section.

### BRIEF DESCRIPTION OF THE DRAWINGS

The above objects, and other features and advantages of the present invention will become more apparent after a reading of the following detailed description taken in conjunction with the drawings, in which:

FIG. 1 is a block diagram illustrating a driving circuit of a conventional liquid crystal display device;

FIG. 2 is a graph showing changes in the output voltages of a gamma buffer and a channel buffer due to power drops in a source driver of the conventional liquid crystal display device;

FIG. 3 is a circuit diagram illustrating a source driver of a liquid crystal display device in accordance with an embodiment of the present invention;

FIG. 4 is a circuit diagram illustrating a source driver of a liquid crystal display device in accordance with another embodiment of the present invention;

FIG. 5 is a graph showing changes in the output voltages of a gamma buffer and a channel buffer due to power drops in the source driver of a liquid crystal display device according to the present invention; and

FIGS. 6(a) and 6(b) are graphs showing that recovery times upon occurrence of a power drop and a ground voltage bouncing are shortened according to the present invention.

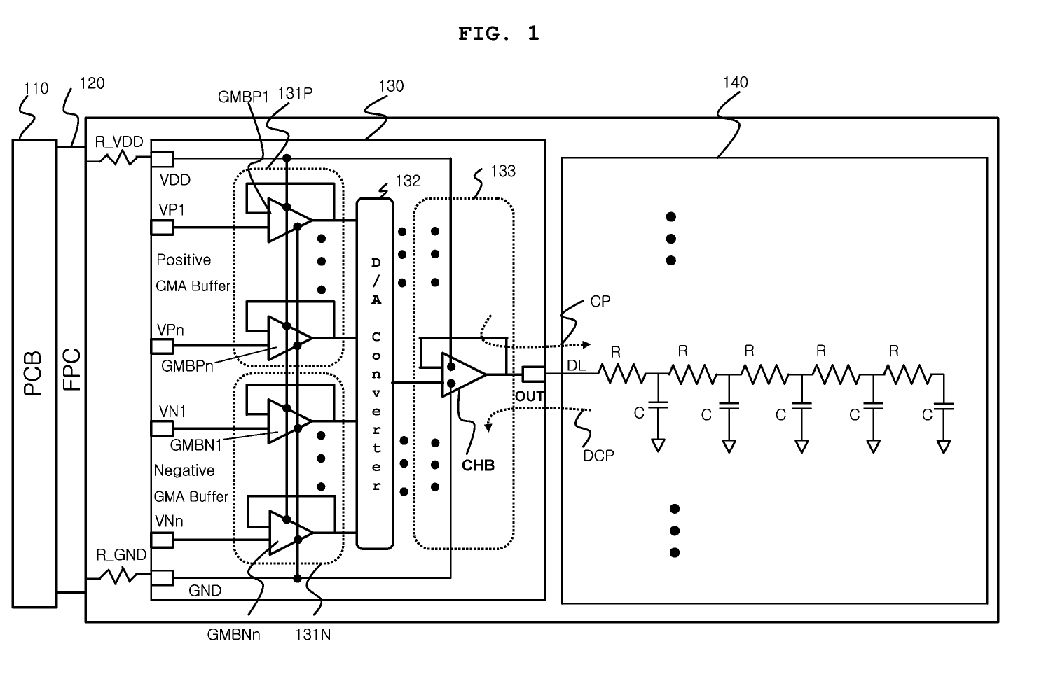

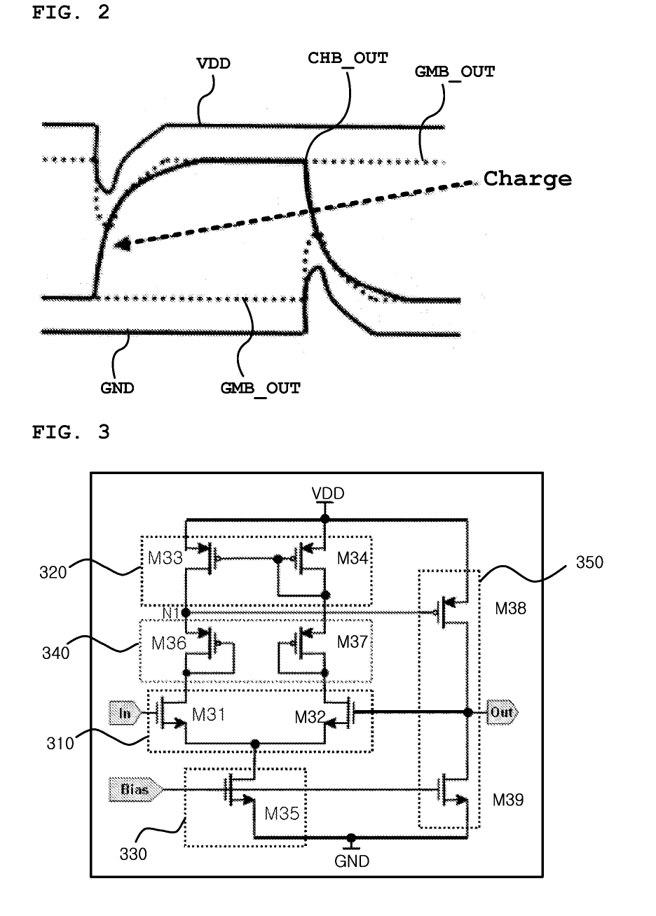

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

FIG. 3 is a circuit diagram of a positive gamma buffer applied to a source driver circuit of a liquid crystal display device in accordance with an embodiment of the present invention. Referring to FIG. 3, the positive gamma buffer includes a differential amplification section 310, a current mirror section 320, an enable section 330, a power drop speed improvement section 340, and an output section 350. The differential amplification section 310 includes NMOS transistors M31 and M32. The NMOS transistor M31 has the gate which is connected to an input terminal IN, and the NMOS transistor M32 has the gate which is connected to an output terminal OUT.

The current mirror section 320 includes PMOS transistors M33 and M34. The sources of the PMOS transistors M33 and M34 are commonly connected to a power supply terminal VDD. The PMOS transistor M34 is a diode coupling type transistor in which the gate and the drain are connected with each other.

The enable section 330 includes an NMOS transistor M35 and functions to convert the differential amplification section 310 from a standby mode to an enable mode. That is to say, the NMOS transistor M35 is turned on when a bias voltage Bias is supplied at a high level and connects the sources of the NMOS transistors M31 and M32 of the differential amplification section 310 to a ground terminal GND, by which the differential amplification section 310 is converted to an activation mode. Accordingly, the NMOS transistor M31 of the differential amplification unit 310 operates in correspondence to the signal inputted through the input terminal IN, as a result of which the voltage of a downstream node N1 is determined.

The power drop speed improvement section 340 includes PMOS transistors M36 and M37 which are connected in a diode type. The sources of the PMOS transistors M36 and M37 are connected to the drains of the PMOS transistors M33 and M34 of the current mirror section 320, and the drains of the PMOS transistors M36 and M37 are connected to the drains of the NMOS transistors M31 and M32 of the differential amplification section 310.

While the MOS transistors M36 and M37 are exemplified as PMOS transistors, it is conceivable that the same effects can be achieved when the MOS transistors M36 and M37 are realized using NMOS transistors.

The output section 350 includes a PMOS transistor M38 and an NMOS transistor M39. The source of the PMOS transistor M38 is connected to the power supply terminal VDD, and the gate of the PMOS transistor M38 is connected to the downstream node N1. The drain of the PMOS transistor M38 is connected commonly to the output terminal OUT, the gate of the NMOS transistor M32, and the drain of the NMOS transistor M39 of which source is connected to the ground terminal GND.

The bias level of the NMOS transistor M39 is determined by the bias voltage Bias, and the PMOS transistor M38 operates by the voltage of the downstream node N1 which is determined as described above, by which a resultant voltage is outputted to the output terminal OUT. As a consequence, an output voltage corresponding to the signal inputted through the input terminal IN is outputted through the output terminal OUT.

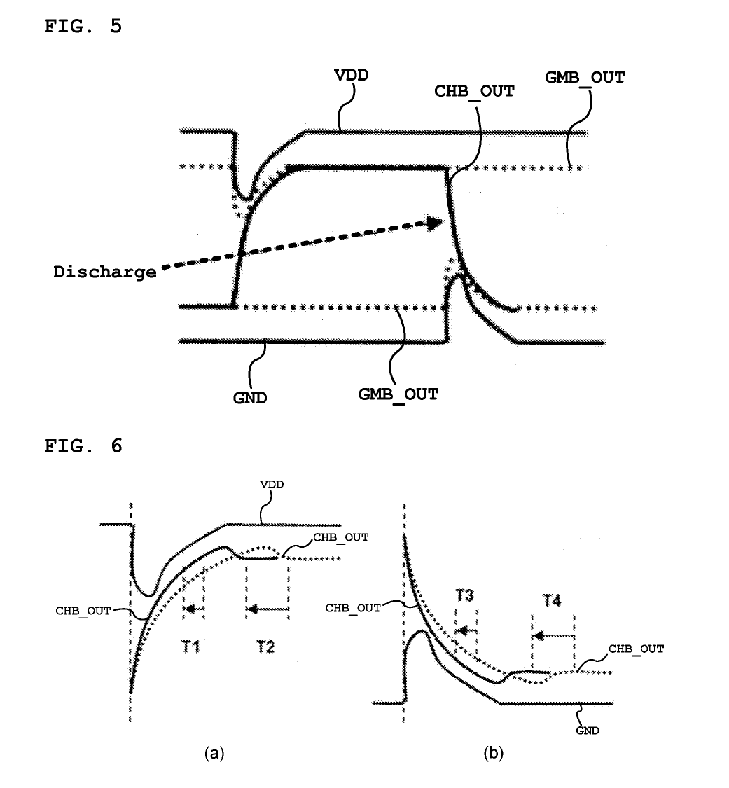

Referring to FIG. 5, if a power drop occurs in the gamma buffer, that is, the voltage of the power supply terminal VDD drops, a drop in the output voltage GMB_OUT of the gamma buffer occurs in a greater extent than the drop in the voltage of the power supply terminal VDD. At this time, since the output voltage GMB_OUT of the gamma buffer is lower than the input voltage IN, the level of the output voltage GMB_OUT is raised to the level of the input voltage IN. To this end, the gate voltage of the PMOS transistor M38, that is, the voltage of the downstream node N1 is lowered.

However, as described above, since the drains of the PMOS transistors M33 and M34 of the load transistors of the current mirror section 320 are connected to the drains of the NMOS transistors M31 and M32 of the differential amplification section 310 by way of the PMOS transistors M36 and M37 of the power drop speed improvement section 340 which are connected in a diode type, the drain-source voltages (V_{DS}) of the PMOS transistors M36 and M37, which are equal to or greater than threshold voltages, are applied between the transistors M33 and M34 and the transistors M31 and M32.

Accordingly, the operation range of the gate of the PMOS transistor M38 is decreased correspondingly. In other words, since a maximum level, to which the voltage level of the downstream node N1 can be lowered, is limited by the threshold voltages of the PMOS transistors M36 and M37, the operation range of the gate of the PMOS transistor M38 is decreased correspondingly.

Describing in detail, the output voltage GMB_OUT of the gamma buffer drops due to a drop in the voltage of the power supply terminal VDD, and in order to recover the output voltage GMB_OUT of the gamma buffer to an original level, the voltage of the downstream node N1 is lowered. When the PMOS transistors M36 and M37 are disposed, the voltage of the downstream node N1 are lowered less by the threshold voltages, compared to the case in which the PMOS transistors M36 and M37 are not disposed. In this way, since the voltage of the downstream node N1 is lowered less by the threshold voltages, a recovery time is shortened correspondingly when raising the voltage of the downstream node N1 to an original level. Due to this fact, the recovery time of the output voltage GMB_OUT of the gamma buffer is shortened correspondingly (see FIG. 5).

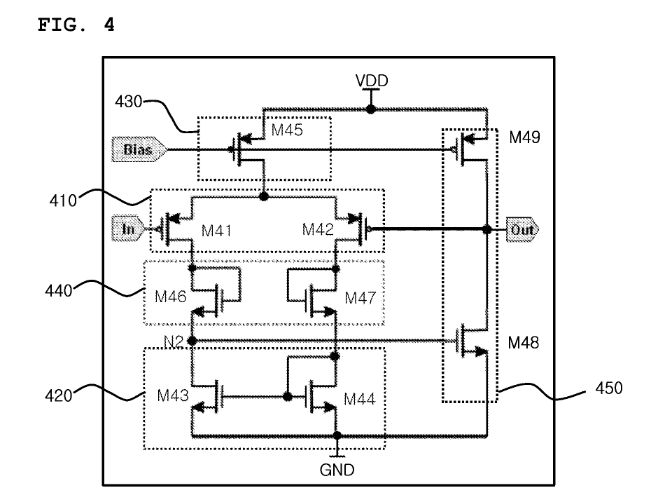

FIG. 4 is a circuit diagram of a negative gamma buffer applied to a source driver circuit of a liquid crystal display device in accordance with another embodiment of the present invention. Referring to FIG. 4, the negative gamma buffer includes a differential amplification section 410, a current mirror section 420, an enable section 430, a power drop speed improvement section 440, and an output section 450.

While the same basic operation principle is adopted in FIGS. 3 and 4, FIGS. 3 and 4 are distinguished from each other in that FIG. 3 represents a positive gamma buffer for dealing with a drop in the voltage of a power supply terminal and FIG. 4 represents a negative gamma buffer for dealing with a bouncing in the voltage of a ground terminal.

The differential amplification section 410 includes PMOS transistors M41 and M42. The PMOS transistor M41 has the gate which is connected to an input terminal IN, and the PMOS transistor M42 has the gate which is connected to an output terminal OUT.

The current mirror section 420 includes NMOS transistors M43 and M44. The sources of the NMOS transistors M43 and M44 are commonly connected to a ground terminal GND. The NMOS transistor M44 is a diode coupling type transistor in which the gate and the drain are connected with each other.

The enable section 430 includes a PMOS transistor M45 and functions to convert the differential amplification section 410 from a standby mode to an enable mode. That is to say, the PMOS transistor M45 is turned on when a bias voltage Bias is supplied at a low level and connects the sources of the PMOS transistors M41 and M42 of the differential amplification section 410 to a power supply terminal VDD, by which the differential amplification section 410 is converted to an activation mode. Accordingly, the PMOS transistor M41 of the differential amplification unit 410 operates in correspondence to the signal inputted through the input terminal IN, as a result of which the voltage of an upstream node N2 is determined.

The power drop speed improvement section 440 includes NMOS transistors M46 and M47 which are connected in a diode type. The sources of the NMOS transistors M46 and M47 are connected to the drains of the NMOS transistors M43 and M44 of the current mirror section 420, and the drains of the NMOS transistors M46 and M47 are connected to the drains of the PMOS transistors M41 and M42 of the differential amplification section 410.

While the MOS transistors M46 and M47 are exemplified as NMOS transistors, it is conceivable that the same effects can be achieved when the MOS transistors M46 and M47 are realized using PMOS transistors.

The output section 450 includes an NMOS transistor M48 and a PMOS transistor M49. The source of the NMOS transistor M48 is connected to the ground terminal VDD, and the gate of the NMOS transistor M48 is connected to the upstream node N2. The drain of the NMOS transistor M48 is connected commonly to the output terminal OUT, the gate of the PMOS transistor M42, and the drain of the PMOS transistor M49 of which source is connected to the power supply terminal VDD.

The bias level of the PMOS transistor M49 is determined by the bias voltage Bias, and the NMOS transistor M48 operates by the voltage of the upstream node N2 which is determined as described above, by which a resultant voltage is outputted to the output terminal OUT. As a consequence, an output voltage corresponding to the signal inputted through the input terminal IN is outputted through the output terminal OUT.

Referring to FIG. 5, if a bouncing occurs in the voltage of the ground terminal GND in the gamma buffer, a bouncing in the output voltage GMB_OUT of the gamma buffer occurs in a greater extent than the bouncing in the voltage of the ground terminal GND. At this time, since the output voltage GMB_OUT of the gamma buffer is higher than the input voltage IN, the level of the output voltage GMB_OUT is started to be lowered to the level of the input voltage IN. To this end, the gate voltage of the NMOS transistor M48, that is, the voltage of the upstream node N2 is raised.

However, as described above, since the drains of the NMOS transistors M43 and M44 of the load transistors of the current mirror section 420 are connected to the drains of the PMOS transistors M41 and M42 of the differential amplification section 410 by way of the NMOS transistors M46 and M47 of the power drop speed improvement section 440 which are connected in a diode type, the drain-source voltages (V_{DS}) of the NMOS transistors M46 and M47, which are equal to or greater than threshold voltages, are applied between the transistors M43 and M44 and the transistors M41 and M42.

Accordingly, the operation range of the gate of the NMOS transistor M48 is decreased correspondingly. In other words, since a maximum level, to which the voltage level of the upstream node N2 can be raised, is limited by the threshold voltages of the NMOS transistors M46 and M47, the operation range of the gate of the NMOS transistor M48 is decreased correspondingly.

Describing in detail, the output voltage GMB_OUT of the gamma buffer bounces due to a bouncing in the voltage of the ground terminal GND, and in order to recover the output voltage GMB_OUT of the gamma buffer to an original level, the voltage of the upstream node N2 is raised. When the NMOS transistors M46 and M47 are disposed, the voltage of the upstream node N2 are raised less by the threshold voltages, compared to the case in which the NMOS transistors M46 and M47 are not disposed. In this way, since the voltage of the upstream node N2 is raised less by the threshold voltages, a recovery time is shortened correspondingly when raising the voltage of the upstream node N2 to an original level. Due to this fact, the recovery time of the output voltage GMB_OUT of the gamma buffer is shortened correspondingly (see FIG. 5).

FIGS. 6(a) and 6(b) are graphs showing that a recovery time upon occurrence of a power drop and a recovery time upon occurrence of a bouncing in the voltage of a ground terminal are shortened according to the present invention. That is to say, it is to be appreciated that the rising time T1 and the falling time T3 in the output voltage of the channel buffer are improved by the gamma buffer operating as shown in FIGS. 3 and 4. Also, it is to be appreciated that the setting times T2 and T4 of the channel buffer are improved by the gamma buffer operating as shown in FIGS. 3 and 4.

As is apparent from the above description, in the embodiments of the present invention, in a gamma buffer circuit adopted in a source driver of a liquid crystal display device, since MOS transistors of a differential amplification section and a current mirror section are connected with each other through diode coupling type MOS transistors, a recovery time after a voltage drop of a power supply terminal and a recovery time after a voltage bouncing of a ground terminal can be shortened. Also, the matching characteristic of an input transistor is improved, and due to this fact, a random offset is reduced.

Although a preferred embodiment of the present invention has been described for illustrative purposes, those skilled in the art will appreciate that various modifications, additions and substitutions are possible, without departing from the scope and the spirit of the invention as disclosed in the accompanying claims.

What is claimed is:

1. A source driver circuit of a liquid crystal display device including a gamma buffer, the gamma buffer comprising:
a differential amplification section having two NMOS transistors and configured to differentially amplify an input signal;
a current mirror section having two PMOS transistors and configured to operate as a current mirror;
an enable section having one NMOS transistor and configured to convert the differential amplification section from a standby mode to an enable mode by a bias voltage;
a power drop speed improvement section configured to respectively connect drains of the two PMOS transistors of the current mirror section and drains of the two NMOS transistors of the differential amplification section through two diode coupling type MOS transistors, and shorten a recovery time after a power drop; and
an output section having a PMOS transistor and an NMOS transistor and configured to be determined in a bias level thereof by the bias voltage and generate an output voltage according to a voltage of a downstream node on one side of the current mirror section.

2. The source driver circuit according to claim 1, wherein the liquid crystal display device comprises a COG (chip-on-glass) type liquid crystal display device.

3. The source driver circuit according to claim 1, wherein the two MOS transistors of the power drop speed improvement section includes both a PMOS transistor and an NMOS transistor.

4. The source driver circuit according to claim 1, wherein the power drop speed improvement section comprises:
a first PMOS transistor having a source which is connected to a drain of a first PMOS transistor of the current mirror section and a gate and a drain which are connected to a drain of a first NMOS transistor of the differential amplification section; and
a second PMOS transistor having a source which is connected to a drain of a second PMOS transistor of the current mirror section and a gate and a drain which are connected to a drain of a second NMOS transistor of the differential amplification section.

5. A source driver circuit of a liquid crystal display device including a gamma buffer, the gamma buffer comprising:
a differential amplification section having two PMOS transistors and configured to differentially amplify an input signal;
a current mirror section having two NMOS transistors and configured to operate as a current mirror;
an enable section having one PMOS transistor and configured to convert the differential amplification section from a standby mode to an enable mode by a bias voltage;
a power drop speed improvement section configured to respectively connect drains of the two PMOS transistors of the differential amplification section and drains of the two NMOS transistors of the current mirror section through two diode coupling type MOS transistors, and shorten a recovery time after a bouncing in a voltage of a ground terminal; and
an output section having an NMOS transistor and a PMOS transistor and configured to be determined in a bias level thereof by the bias voltage and generate an output voltage according to a voltage of an upstream node on one side of the current mirror section.

6. The source driver circuit according to claim 5, wherein the two MOS transistors of the power drop speed improvement section includes both a PMOS transistor and an NMOS transistor.

7. The source driver circuit according to claim 5, wherein the power drop speed improvement section comprises:
a first NMOS transistor having a drain and a gate which are connected to a drain of a first PMOS transistor of the differential amplification section and a source which is connected to a drain of a first NMOS transistor of the current mirror section; and
a second NMOS transistor having a drain and a gate which are connected to a drain of a second PMOS transistor of the differential amplification section and a source which is connected to a drain of a second NMOS transistor of the current mirror section.

8. The source driver circuit according to claim 5, wherein the liquid crystal display device comprises a COG (chip-on-glass) type liquid crystal display device.
